(19) United States
(12) Patent Application Publication
(10) Pub. No.: US 2012/0000428 A1
(43) Pub. Date: Jan. 5, 2012

(54) SMALL ANIMAL BEDDING SYSTEM

(75) Inventors: Eileene E. Keating, Kennesaw, GA (US); Michael O. Story, Conyers, GA (US)

(73) Assignee: GEORGIA-PACIFIC WOOD PRODUCTS LLC, Atlanta, GA (US)

(21) Appl. No.: 13/174,024

(22) Filed: Jun. 30, 2011

Related U.S. Application Data
(60) Provisional application No. 61/360,861, filed on Jul. 1, 2010.

(51) Int. Cl. A01K 1/015; A01K 29/00; D21B 1/04

(52) U.S. Cl. 119/28.5; 264/115

(57) ABSTRACT

An animal bedding system having a hydrophilic fiberboard substrate and hydrophobic fiberboard bedding disposed on top of the fiberboard substrate. The fiberboard bedding can be hogged or chopped to provide a soft nesting area for the animal and also keep the animal dry.

### CROSS-REFERENCE TO RELATED APPLICATION

This application claims priority to U.S. Patent Application No. 61/360,861, filed on Jul. 1, 2011, the entirety of which is incorporated herein by reference.

### BACKGROUND OF THE INVENTION

1. Field of the Invention

Embodiments provided herein generally relate to animal bedding. More particularly, the embodiments relate to a fiberboard bedding system containing both hydrophilic and hydrophobic fiberboard material.

2. Description of the Related Art

Small animals, such as rabbits, hamsters, guinea pigs, mice, rats, ferrets, etc., are typically housed in cages. Animal bedding is typically placed in such cages to provide cushion, support, and/or warmth, which are essential to the comfort of the animal. Absorbent animal bedding is often used to absorb animal droppings and urine as well as animal musk and smells emanating from the droppings. Such bedding, if it is disposable, is generally based on wood products, such as cedar and/or pine shavings, cellulosic materials, recycled and chopped paper products, chopped cobs, etc.

The use of such bedding, however, has a serious drawback in that unless the cage is kept immaculately clean, the bedding material can begin to smell and convey that odor onto the fur of the animal itself. Moreover, under-cleaned bedding can be detrimental to the health and general wellbeing of the animal. The need to groom the bedding and sometimes completely replace the bedding every few days for hygienic reasons can potentially constitute a high cost in labor and replacement materials.

What is needed, therefore, is an improved animal bedding system that is not only absorbent but also provides a soft nesting area for the animal.

### SUMMARY OF THE INVENTION

Small animal bedding systems are provided. In at least one specific embodiment, the animal bedding system includes a hydrophilic fiberboard substrate covered with a layer of hydrophobic chopped fiberboard bedding. The hydrophobic bedding repels animal urine and droppings, thereby allowing the substances to drop to the hydrophilic fiberboard substrate. The fiberboard can be made of one or more compressed fibers, such as wood fibers or lignocellulosic fibers.

### BRIEF DESCRIPTION OF THE DRAWINGS

So that the recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an exploded isometric view of an illustrative animal bedding system 100 according to one or more embodiments described.

FIG. 2 depicts an exploded isometric view of another illustrative animal bedding system according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

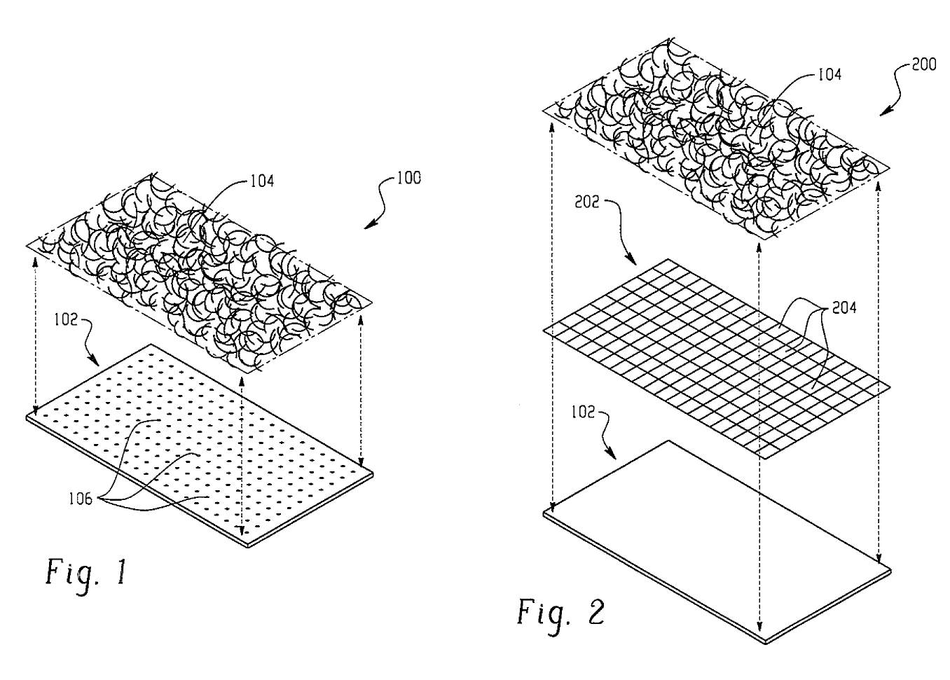

FIG. 1 depicts an exploded isometric view of an illustrative animal bedding system 100 according to one or more embodiments. The animal bedding system 100 can include a fiberboard substrate 102 at least partially covered by fiberboard bedding 104. The fiberboard substrate 102 and fiberboard bedding 104 are offset in FIG. 1 for illustrative purposes. During use, however, the fiberboard bedding 104 is placed on top of the fiberboard substrate 102, and an animal lies on top of the fiberboard bedding 104.

The fiberboard substrate 102 can be or include a hydrophilically-treated fiberboard and configured to absorb liquids from the animal's immediate environment. The fiberboard bedding 104 can be or include a hydrophobically-treated fiberboard material and configured to provide continued dry bedding for keeping the animal comfortable and dry. In at least one embodiment, the fiberboard bedding 104 includes small bits and pieces of chopped or “hogged” fiberboard. Because the fiberboard bedding 104 is hydrophobic and chopped into small pieces, animal droppings and urine will have a propensity to drop through the bedding 104 and be captured on the fiberboard substrate 102 therebelow. As can be appreciated, this allows the animal to remain out of contact with its excreta, while simultaneously providing a soft and dry resting area.

The fiberboard substrate 102 can include a series of perforations 106 on at least a portion of one surface of the fiberboard substrate 102. In other embodiments, the perforations 106 can be placed over the whole surface of the fiberboard substrate 102. In an embodiment, the perforations 106 can include indentations formed into the surface of the fiberboard substrate 102 to facilitate size adjustment of the substrate 102. For example, the fiberboard substrate 102 can be broken or otherwise separated along co-linear perforations 106 so as to manually size the substrate 102 to the general dimensions of a particular animal's cage.

The fiberboard that makes up the fiberboard substrate 102 and the fiberboard bedding 104 can include one or more compressed fibers. For example, the fiberboard can include up to 99 wt % fibers, based on the total weight of the fiberboard. In one or more embodiments, the fiberboard includes up to 98 wt %, 97 wt %, 96 wt %, 95 wt %, 90 wt %, 85 wt %, 80 wt %, 75 wt %, 70 wt %, 65 wt %, 60 wt %, 55 wt %, 50 wt %, 40 wt %, 35 wt %, or 30 wt % fibers based on the total weight of the fiberboard. In one or more embodiments, the fiberboard includes at least 50 wt %, 55 wt %, 60 wt %, 65 wt %, 70 wt %, 75 wt % , 80 wt %, 85 wt %, 88 wt %, 90 wt %, 92 wt %, 93 wt %, 94 wt %, 95 wt %, 96 wt %, 97 wt %, or 98 wt % fibers based on the total weight of the fiberboard. The amount of fibers in the fiberboard can also range from a low of about 50 wt %, 60 wt %, or 70 wt % to a high of about 85 wt %, 95 wt % or 99 wt %, based on the total weight of the fiberboard.

In one or more embodiments, the fiberboard can include less than 20 wt %, 15 wt %, 10 wt %, 9 wt %, 8 wt %, 7 wt %, 6 wt %, 5 wt %, 4 wt %, 3 wt %, 2 wt %, 1 wt %, 0.5 wt %, 0.3 wt %, or 0.1 wt % combined weight of resin and wax, based on the total weight of the fiberboard. As can be appreciated, resins and waxes can help the fiberboard achieve hydrophobic characteristics. The amount of combined resin and wax can range from a low of about 0.1 wt %, 0.5 wt %, 1 wt % to a high of about 2 wt %, 3.5 wt %, or 5 wt %, based on the total weight of the fiberboard. In at least one embodiment, it is the resin and wax content that makes the fiberboard bedding 104 hydrophobic.

In one or more embodiments, the fiberboard can include less than 5 wt %, 4 wt %, 3 wt %, 2 wt %, 1 wt %, 0.5 wt %, 0.3 wt %, or 0.1 wt % resin, based on the total weight of the fiberboard. The amount of resin can range from a low of about 0.1 wt %, 0.5 wt %, 1 wt % to a high of about 2 wt %, 3.5 wt %, or 5 wt %, based on the total weight of the fiberboard.

In one or more embodiments, the fiberboard includes less than 5 wt %, 4 wt %, 3 wt %, 2 wt %, 1 wt %, 0.5 wt %, 0.3 wt %, or 0.1 wt % wax, based on the total weight of the fiberboard. The amount of wax can range from a low of about 0.1 wt %, 0.5 wt %, 1 wt % to a high of about 2 wt %, 3.5 wt %, or 5 wt %, based on the total weight of the fiberboard.

In at least one embodiment, the fiberboard contains no resins or waxes, or the fiberboard can be substantially free of added resins and waxes. The term “substantially free of added resins and waxes,” as used herein, can refer to a fiber or fiberboard having no added resins and waxes. In other embodiments, the only resins and waxes present in the fiber or fiberboard is a negligible amount, such as less than 5 wt % based on the total weight of the fiberboard, contained with any surfactant, fiber, or colorant used to make the fiber or fiberboard. In other words, according to one or more embodiments of the present invention, no resins or waxes are intentionally added to the fiber or fiberboard. In at least one embodiment, a fiberboard substantially free of added resins and waxes is a fiberboard that contains less than about 5%, less than about 3%, less than about 2%, less than about 1%, or less than about 0.5% of a combined amount of resin and wax, based on the total weight of the fiberboard including any coatings disposed thereon.

The fibers or fibrous materials in the fiberboard substrate 102 and/or fiberboard bedding 104 can include, but are not limited to, organic-based fibers and materials. Because the fiberboard is organic, it can be disposed of environmentally, instead of filling up landfills with non-degradable waste. In at least one embodiment, the fiberboard substrate 102 can be disposed of as mulch in, for example, a garden where it will decompose and provide valuable nutrients for the soil.

Organic-based fibers can include, but are not limited to, lignocellulosic fibers (fibers that comprise both cellulose and lignin); straw; hemp; sisal; cotton stalk; wheat; bamboo; sabai grass; rice straw; banana leaves; paper mulberry (i.e., bast fiber); abaca leaves; pineapple leaves; esparto grass leaves; fibers from the genus Hesperaloe in the family Agavaceae jute; salt water reeds; palm fronds; flax; ground nut shells; hardwoods; softwoods; recycled fiberboards such as high density fiberboard; medium density fiberboard; low density fiberboard; oriented strand board; particle board; animal fibers (e.g., wool, hair); recycled paper products (e.g., newspapers, cardboard, cereal boxes, and magazines); or any combination thereof. In at least one specific embodiment, the fiber material can include wood, such as hardwoods, softwoods, or a combination thereof. The wood can include, but is not limited to, cedar and/or pine shavings, chopped cellulosic materials, or chopped paper products. In one embodiment, the fiber material can be derived from a green wood mixture, such as a mixture of southern pine and mixed hardwood chips. The wood mixture can contain about 84% southern pine and about 16% mixed hardwood.

Suitable forms of starting fiber materials can be or include one or more chips, shavings, boards, logs, panels, sheets of paper, cardboard, sawdust, or the like. In one or more embodiments, the fibers can be from a chemical pulp obtained from softwood and/or hardwood chips liberated into fiber by sulfate, sulfite, sulfide or other chemical pulping processes. In other embodiments, the fibers can be obtained from a fiber material by mechanical based methods. For example, a fiber groundwood pulp can be obtained by mechanical treatment of softwood and/or hardwood mixed with process water, recycled fiber, and other refined fiber in one or more refiners. The fibrillation of the groundwood pulp can be controlled by maintaining a consistency of about 28% to about 32% at the inlet of each refiner.

The developed pulp and starting fiber material can then be reduced in consistency and size by softening the starting fiber material with steam and pressure and then mechanically grinding the fiber material in a grinder to produce the desired fiber size. The fiber material can be reduced to a length ranging from a low of about 0.05 mm, about 0.1 mm, about 0.2 mm to a high of about 1 mm, about 5 mm, about 10 mm, or about 20 mm. In at least one embodiment, the consistency of the pulp can be reduced to about 3.5%.

One or more additives can be added to the starting fiber material. Illustrative additives can include, but are not limited to, defoamers, antifoamers, dispersants, lubricants, crosslinkers, antislipping agents, thickeners, fire retardants, flocculating agents, ph adjusters, binders, and insolubilizers. In at least one embodiment, a wax emulsion can be added to the starting fiber material to obtain water resistive properties. Moreover, aluminum sulfate may also be added to the starting fiber material to activate the wax emulsion, thereby allowing the wax to adhere to the individual fibers.

The fiberboard can be made using any suitable fabrication process. In at least one embodiment, the fiberboard can be made using a wet process. For example, the fibers can be mixed with water to provide a fiber/liquid slurry. The fiber/liquid slurry can contain about 50% or more, about 60% or more, about 70% or more, about 80% or more, about 90% or more, or about 100% water. In at least one embodiment, the fiber/liquid slurry can be mixed with additional process water to reduce the consistency to about 1.3% to about 1.5%. The fiber/liquid slurry can then be fed into a headbox having a series of rectifier rolls (i.e., “holey rolls”) and baffles adapted to distribute the fibrous material evenly across a planar substrate. In at least one embodiment, the fibrous material can be distributed across a substrate length of about 13.5 feet.

The distributed fibrous material can then be transported over a making board and down into a cylinder mould or vat containing a counterflow vacuum cylinder. In one or more embodiments, the counterflow vacuum cylinder can rotate at about 46 rpm. As the cylinder rotates, the fibrous material forms a mat on the interior surface, aided by the internal vacuum. While being rotated in the cylinder, the wet fiber mat can be pressed between one or more rolls in series and a 400 cubic feet per minute (“cfm”) permeable spiral wire belt to generate a formed mat. The resulting fiber mat can include a ⅝ inch thick mat of about 24% consistency. In an embodiment, the fiber mat can include about 80% moisture content or less, about 70% moisture content or less, about 60% moisture content or less, about 50% moisture content or less, about 40% moisture content or less, or about 30% moisture content or less. As used herein, the term “moisture content” refers to the amount of water in the fiberboard, based on total weight percent of the fiberboard and water.

The wet fiber mat can then be removed from the cylinder and pressed in one or more press devices, rollers, or the like to remove additional liquid. In at least one embodiment, the continuous fiber mat is sent through a series of two or more powered rollers adapted to remove excess water. The pressure applied to the fiberboard in the rollers can be about 350 kPa or more, about 700 kPa or more, about 1500 kPa or more, about 3,000 kPa or more, about 6,000 kPa or more, or about 9,000 kPa or more. For example, the pressure applied to the fiberboard can range from about 3,500 kPa to about 8,500 kPa, or from about 4,500 kPa to about 8,000 kPa, or from about 5,500 kPa to about 7,700 kPa. The applied pressure can be configured to remove about 40% or more, about 60% or more, about 70% or more, about 80% or more, or about 90% or more of the remaining liquid from the fiber mat to provide a fiberboard suitable to be used as the substrate fiberboard 102 and/or the fiberboard bedding 104. The resulting fiberboard can have about 10% moisture content or less, about 7% moisture content or less, about 6% moisture content or less, about 5% moisture content or less, about 4% moisture content or less, or about 3% moisture content or less, about 2% moisture content or less, or about 1% moisture content, or less than about 1% moisture content.

The fiberboard can also be conveyed through at least two spiral wire belts of 900 cfm permeability in order to dewater the fiberboard to about 42% consistency. In an embodiment, after rolling and dewatering the fiberboard, the resulting fiberboard can be about 0.560 inches thick. As can be appreciated, however, various thicknesses can be achieved by altering the various processing parameters disclosed herein. In at least one embodiment, the fiberboard can be cut into predetermined lengths for drying and storage. For example, the fiberboard can be cut into 18 foot lengths with a high pressure water jet.

The fiberboard can also be heated to remove a portion of any remaining or excess liquid. In at least one embodiment, the fiberboard can be heated before the fiber mat is pressed, while the fiber mat is pressed, after the fiber mat is pressed, or any combination thereof. The fiberboard can be dried in the press device, a kiln, by exposure to the atmosphere for a period of time, or by heated air, heating elements, or any other suitable heating method. In at least one embodiment, the fiberboard is heated at a temperature of about 50° C. or more, about 100° C. or more, about 150° C. or more, about 200° C. or more, about 250° C. or more, or about 300° C. or more. For example, the pressed fiberboard can be heated to a temperature of from about 100° C. to about 260° C., about 150° C. to about 240° C., or about 170° C. to about 220° C.

The heat applied to the fiberboard for drying can be maintained for a predetermined period of time. Such duration can range from a low of about 10 minutes, about 20 minutes, or about 30 minutes to a high of about 50 minutes, about 70 minutes, or about 100 minutes. In at least one embodiment, the heat can be applied to the fiberboard for drying for about 75 minutes to obtain a fiberboard moisture content of about 6% to about 8%. In one or more embodiments, the fiberboard can be heated in a kiln for a period of minutes or hours. In one or more embodiments, the fiberboard can be air dried for a period of hours, days, weeks, or months.

In addition to removing at least a portion of any remaining liquid in the fiberboard, heating the fiberboard can also serve to sterilize the fiberboard. Indeed, the heat applied to the fiberboard can serve to kill or otherwise neutralize bacteria, fungus, viruses, microbes, or the like that may be on, in, or about the fiberboard. Heating the fiberboard can also serve to reduce harmful, naturally-occurring aromaticity common in cedar products, and also neutralize abeitic acids in pine which has been shown to be an allergen to animals.

The density of the resulting fiberboard can range from a low of about 0.50 g/cm³, about 0.65 g/cm³, or about 0.70 g/cm³ to a high of about 0.90 g/cm³, about 1.1 g/cm³, or about 1.4 g/cm³. In one or more embodiments, density of the fiberboard can range form a low of about 0.40 g/cm³, about 0.50 g/cm³, or about 0.60 g/cm³ to a high of about 0.65 g/cm³, about 0.70 g/cm³, or about 0.80 g/cm³.

As a result of the drying and pressing processes, the fiberboard can have a thickness ranging from a low of about 5 mm, about 7 mm, or about 10 mm to a high of about 14 mm, about 17 mm, or about 20 mm. In at least one embodiment, the resulting fiberboard can have a thickness of about 12 mm to about 13 mm. The fiberboard can then be trimmed into sheets of fiberboard of varying lengths and widths. As can be appreciated, the length and width of the fiberboard can be altered manually or by machine after the fiberboard is completely manufactured. In an embodiment, the fiberboard is cut into 4′×9′ sheets for handling and storage.

After pressing and drying the fiberboard, both the fiberboard bedding 104 and the fiberboard substrate 102 can be prepared from the finished product. Because of the wax and/or resin content present in the fiberboard, the fiberboard can be substantially hydrophilic, and suitable for making the fiberboard bedding 104. The fiberboard bedding 104 can be made by chopping or “hogging” the final fiberboard product into small hydrophilic fiberboard pieces. The small pieces of fiberboard bedding 104 can be obtained in any way known in the art, including, but not limited to, shredding, chipping, and/or mulching the finished fiberboard product. In at least one embodiment, individual fiberboard board can be fed into a mechanical grinder to produce material that passes through a 0.5 inch screen but is retained on a 0.25 inch screen. The finished hogged material can have a bulk density of about 2.5 lbs/ft³ (0.04 g/cm³). Any oversized material can be processed back through the mechanical grinder and any fines are recycled back into the creation of new fiberboard. Once hogged from the fiberboard, the fiberboard bedding 104 can be bagged or otherwise collected for storage or shipping.

The substrate fiberboard 102 can be prepared by applying one or more surfactants to one or more sides of the finished fiberboard product. Treating the fiberboard with a surfactant can make the fiberboard hydrophilic, or increase its absorbency and rate at which the fiberboard absorbs liquids. As can be appreciated, therefore, the surfactant can make the substrate fiberboard 102 suitable for the animal bedding system 100, where the substrate fiberboard 102 is configured to receive and trap animal excreta, and also capture and mask odors emanating from the excreta and the animal itself.

The surfactant can be applied to the fiberboard using any suitable process, such as spraying, brushing, rolling, or the like. In one or more embodiments, the fiberboard can include from about 1 wt % to about 40 wt % surfactant, based on the total weight of the fiberboard. The surfactant also can be present in an amount of from about 1 wt %, 5 wt %, or 10 wt % to a high of about 15 wt %, 25 wt %, or 40 wt %. In one or more embodiments, the surfactant can be present in an amount of from about 3 wt % , 5 wt %, or 7 wt % to a high of about 9 wt %, 15 wt %, or 18 wt %. The amount of surfactant can also range from about 1 wt % to about 25 wt %; about 3 wt % to about 20 wt %; about 5 wt % to about 15 wt %; or about 5 wt % to about 10 wt %.

The surfactant can be non-ionic, cationic, anionic, and/or amphoteric. In one or more embodiments, the surfactant can be substantially free of polyoxyethylene groups. In one or more embodiments, the surfactant can be or include halogen-capped (e.g., chlorine capped) surfactants, linear alcohol-based surfactants, or alkoxylated (e.g., ethoxylated or propoxylated) alcohol surfactants. In at least one specific embodiment, the surfactant can be or include branched alcohol ethoxylates, for example decyl alcohol ethoxylates having a Hydrophile/Lipophile Balance (“HLB”) value ranging from a low of about 7, about 9, or about 11 to a high of about 13, about 14, or about 15. Illustrative and commercially-available surfactants can include, but are not limited to the RhodaSurf® DA series of non-ionic surfactants available from Rhodia, which are described as branched isodecyl alcohol ethoxylates. For example, the surfactant can be or include RhodaSurf DA-639, which is a 90% solution of RhodaSurf DA-630, which has been described as having 6 moles of ethoxylation and an HLB of 12.5. Other illustrative and commercially-available surfactants can include, but are not limited to, Surfonic® surfactants available from Huntsman, Marlipal® and Alonic surfactants available from Sasol, Desonic surfactants available from Crompton, Trycol® surfactants available from Cognis, Iconol surfactants available from BASF, and Genapol® surfactants available from Clariant.

In at least one embodiment, the surfactant can be applied to the fiberboard while the fiberboard is at an elevated temperature. For example, the surfactant can be applied shortly after the fiberboard is heated, if the fiberboard is heated. If the fiberboard is allowed to air dry, the fiberboard can be heated prior to applying the surfactant. The surfactant can be applied to the fiberboard when the fiberboard is at a temperature of about 30° C. or more, about 50° C. or more, about 75° C. or more, about 100° C. or more, about 125° C. or more, or about 150° C. or more. Applying the surfactant to the fiberboard, while the fiberboard is at an elevated temperature, can increase the rate of absorbency of the solution into the fiberboard and/or improve the uniformity of the surfactant on the fiberboard surfaces.

As a result of the manufacturing processes detailed above, the fiberboard substrate 102 can be structurally-rigid while also capable of absorbing moisture. During use, once the fiberboard substrate 102 has become saturated with liquids, damaged, or otherwise has exceed its practical period of use, it can be removed and replaced. Since the fiberboard substrate 102 is made of organic materials (e.g., wood-based), it can be recycled via a compost pile, a garden, or the like, thereby reducing waste disposal in landfills and the costs associated therewith, while at the same time providing useful compost or fertilizer. Moreover, because the fiberboard bedding 104 is generally hydrophobic, it can be reused many times before requiring complete replacement. During use, the fiberboard bedding 104 will generally repel animal excreta, thereby passing those substances to the fiberboard substrate 102 therebelow.

Referring now to FIG. 2, depicted is an exploded isometric view of another illustrative animal bedding system 200 according to one or more embodiments. The system 200 can include a fiberboard substrate 102 and a layer of fiberboard bedding 104 substantially similar to the embodiments disclosed above with reference to FIG. 1. The system 200 can also include a screen layer 202 interposed between the fiberboard substrate 102 and fiberboard bedding 104. The fiberboard substrate 102, screen layer 202, and fiberboard bedding 104 are shown in FIG. 2 offset from one another for illustrative purposes. During use, however, the screen layer 202 lies on top of the fiberboard substrate 102, the fiberboard bedding 104 lies on top of the screen layer 202, and an animal can lay on top of the fiberboard bedding 104.

The screen layer 202 can be configured to separate the fiberboard bedding 104 from the fiberboard substrate 102, which can be advantageous for cleaning purposes. The screen layer 202 can include or otherwise define a plurality of holes 204 or passageways. The holes 204 can be small enough to prevent the fiberboard bedding 104 from passing therethrough, but large enough to allow the passage of animal droppings and urine to the fiberboard substrate 102 therebelow. Once it is decided to replace the fiberboard substrate 102, the screen layer 202 can be lifted from the fiberboard substrate 102, thereby capturing all or a majority of the fiberboard bedding 104. After the fiberboard substrate 102 is replaced, the screen layer 202, with the fiberboard bedding 104 capture thereon, can be restored to its original position.

In one or more embodiments, the screen layer 202 can be a framed mesh element. The frame could be made of any rigid material, such as metals, plastics, or woods. In other embodiments, the screen layer 202 can be a flexible wire mesh element, wherein the wire can include metal wiring or plastic wiring.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An animal bedding system, comprising:
a hydrophilic fiberboard substrate; and
a layer of chopped fiberboard bedding disposed proximal the fiberboard substrate, wherein the fiberboard bedding is hydrophobic.

2. The animal bedding system of claim 1, wherein the fiberboard substrate and fiberboard bedding comprise one or more compressed fibers.

3. The animal bedding system of claim 2, wherein the one or more compressed fibers are derived from wood.

4. The animal bedding system of claim 2, wherein the one or more compressed fibers are lignocellulosic.

5. The animal bedding system of claim 1, wherein the fiberboard substrate defines a plurality of perforations configured to allow a user to adjust the size of the fiberboard substrate.

6. The animal bedding system of claim 1, wherein the fiberboard substrate and fiberboard bedding are heated to a temperature of about 100° C. to reduce aromaticity and neutralize abeitic acid content.

7. The animal bedding system of claim 1, wherein a surfactant is applied to the fiberboard substrate to make it hydrophilic.

8. The animal bedding system of claim 1, further comprising a screen layer interposed between the fiberboard substrate and the fiberboard bedding.

9. The animal bedding system of claim 8, wherein the screen layer defines a plurality of holes configured to prevent the fiberboard bedding from passing therethrough.

10. A method for making an animal bedding system, comprising:
mixing a fiber material with process water to provide a mixture;
conveying the mixture through one or more refiners to produce groundwood pulp;
adding a wax emulsion to the groundwood pulp to make the fiber material hydrophobic;
removing a first portion of the process water from the groundwood pulp to provide a fiber mat;
conveying the fiber mat between rollers to remove a second portion of the water from the fiber mat to provide a fiberboard;
drying the fiberboard; and
hogging a first portion of the fiberboard into small hydrophilic fiberboard pieces to provide hydrophilic fiberboard bedding; and
applying a surfactant to a second portion of the fiberboard to provide a hydrophilic fiberboard substrate.

11. The method of claim 11, further comprising disposing the hydrophobic fiberboard bedding proximal the hydrophilic fiberboard substrate, wherein the hydrophobic fiberboard bedding repels animal excreta and the hydrophilic fiberboard substrate absorbs the animal excreta.

12. The method of claim 11, wherein the fiber material comprises wood fibers.

13. The method of claim 13, wherein the wood fibers comprise a mixture of southern pine and mixed hardwood chips.

14. The method of claim 11, further comprising adding aluminum sulfate to the groundwood pulp to activate the wax emulsion.

15. The method of claim 11, wherein the small hydrophilic fiberboard pieces are created using a mechanical grinder.

16. The method of claim 11, further comprising heating the fiberboard to a temperature of about 100° C. to reduce aromaticity and neutralize abeitic acid content.

17. The method of claim 11, further comprising adjusting the size of the hydrophilic fiberboard substrate by broking the hydrophilic fiberboard substrate along a series of co-linear perforations defined therein.

18. An animal bedding system, comprising:
a hydrophilic fiberboard substrate;
a hydrophobic fiberboard bedding disposed proximal the fiberboard substrate, the fiberboard bedding being a layer of chopped hydrophobic fiberboard; and
a screen layer interposed between the fiberboard substrate and the fiberboard bedding.

19. The system of claim 18, wherein the fiberboard bedding and substrate are made from a green wood mixture of southern pine and mixed hardwoods.

20. The system of claim 18, wherein the fiberboard bedding and substrate are made from a groundwood pulp comprising a wax emulsion and aluminum sulfate to activate the wax emulsion.
